(19) United States
(12) Patent Application Publication
(10) Pub. No.: US 2017/0004328 A1
(43) Pub. Date: Jan. 5, 2017

(54) INTERACTION METHOD AND DISPLAY DEVICE

(71) Applicant: Beijing Zhigu Rui Tuo Tech Co., Ltd., Beijing (CN)

(72) Inventor: Jia LIU, Beijing (CN)

(21) Appl. No.: 15/200,557

(22) Filed: Jul. 1, 2016

(30) Foreign Application Priority Data
Jul. 3, 2015 (CN) 201510387939.2

(51) Int. Cl. G06F 21/62; G06F 3/0484; G06F 17/22; G06F 3/0488

(52) U.S. Cl. CPC G06F 21/6245; G06F 3/0488; G06F 3/0484; G06F 17/2264; G06F 2203/04808

(57) ABSTRACT

The embodiments of the present invention provide an interaction method and a display device. The interaction method comprises: displaying, by a display device, first information; and providing second information for a user in a touch manner, wherein the second information is used for combining with the first information to obtain third information. The embodiments of the present invention provide an interaction solution.

### BACKGROUND

Technical Field

The embodiments of the present invention relate to the field of interaction technologies, and in particular, to an interaction method and a display device.

Related Art

Many electronic devices are provided with display screens. A user is used to check various pieces of information on a display screen, comprising privacy information of the user. However, information displayed on the display screen is easily saw by other users, the privacy information of the user is possibly stolen by a malicious user, and thus a secure solution is required.

### SUMMARY

In view of the above, an objective of the embodiments of the present invention is to provide an interaction solution.

For the objective, a first aspect of the embodiments of the present invention provides an interaction method, comprising:

displaying, by a display device, first information; and

providing second information for a user in a touch manner, wherein the second information is used for combining with the first information to obtain third information.

For the objective, a second aspect of the embodiments of the present invention provides a display device, comprising:

a display module, configured to display first information; and

a touch control module, configured to provide second information for a user in a touch manner, wherein the second information is used for combining with the first information to obtain third information.

For the objective, a third aspect of the embodiment of the present invention provides a display device, comprising:

at least one display screen, configured to display;

a memory, configured to store an instruction; and

a processor, configured to execute the instruction stored by the memory, wherein the instruction enables the processor to execute the following operations:

controlling the at least one display screen to display first information; and

providing second information for a user in a touch manner, wherein the second information is used for combining with the first information to obtain third information.

At least one of above technical solutions has the following beneficial effects:

According to the embodiments of the present invention, first information is displayed by a display device, and second information is used for combining with the first information to obtain third information, thereby providing an interaction solution. Specifically, disguise information of real information is displayed and assistant information capable of restoring the disguise information is provided for the user in a relatively secret touch manner, to cause the user to restore the disguise information to the real information, thereby improving security and privacy.

### BRIEF DESCRIPTION OF THE DRAWINGS

FIG. 1 is a schematic flow chart of an embodiment of an interaction method provided by the present invention;

FIG. 2 is a schematic structural diagram of a first embodiment of a display device provided by the present invention;

FIG. 3 to FIG. 6 are schematic structural diagrams of an implementing manner of the embodiment as shown in FIG. 2;

FIG. 7 is a schematic structural diagram of a second embodiment of a display device provided by the present invention; and

FIG. 8 is a schematic structural diagram of an implementing mode of the embodiment as shown in FIG. 7.

### DETAILED DESCRIPTION

Specific implementing manners of the present invention are described in further detail below with reference to the accompanying drawings and embodiments. The following embodiments are only intended to describe the present invention, but not to limit the scope of the present invention.

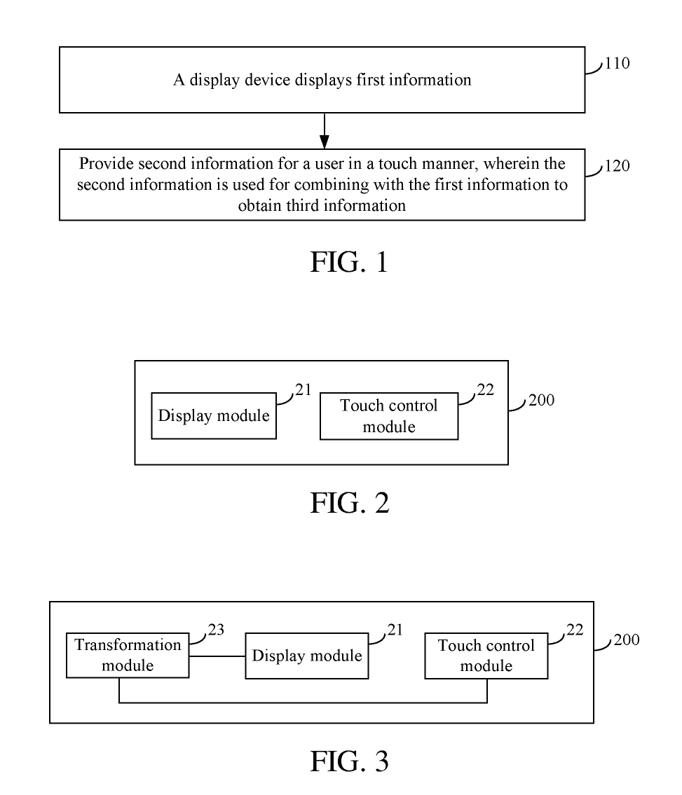

FIG. 1 is a schematic flow chart of an embodiment of an interaction method provided by the present invention. As shown in FIG. 1, this embodiment comprises:

110: A display device displays first information.

In this embodiment, the display device can be any device having a display function, comprising but not limited to: a cellphone, a tablet computer, a wearable device and a display.

In this embodiment, the display device optionally comprises a display screen, displaying, by a display device, first information specifically is displaying the first information on the display screen, and correspondingly, all users located within a view angle range of the display screen can see the first information.

120: Provide second information for a user in a touch manner, wherein the second information is used for combining with the first information to obtain third information.

In this embodiment, since only the two contact parties can perceive the information provided in the touch manner, that is, in the process that the display device provides the second information for the user in the touch manner, the second information cannot be perceived by another user besides the user, that is, it is impossible for the another user to obtain the second information in the process that the display device provides the second information for the user in the touch manner.

In this embodiment, the third information is different from the first information, wherein the third information is information that the display device really wants to provide for the user and can be called as real information; the first information can be regarded as disguised third information, and can be called as disguise information correspondingly; and the second information can assist the user in restoring the disguise information to the real information and is called as assistant information correspondingly.

In this embodiment, the third information is optionally privacy information the privacy information comprises but not limited to any one of the following: an account, a password and a command.

In this embodiment, the third information optionally consists of at least one character.

In this embodiment, an executing sequence of 110 and 120 can be random. Specifically, the display can execute 120 after 110, can execute 120 before 110 or execute 110 and 120 at the same time.

In this embodiment, first information is displayed by a display device, and second information is provided for a user in a touch manner and is used for combining with the first information to obtain third information, thereby providing an interaction solution. Specifically, disguise information of real information is displayed and assistant information capable of restoring the disguise information is provided for the user in a relatively secret touch manner, to cause the user to restore the disguise information to the real information, thereby improving security and privacy.

The method of this embodiment is further described in some optional implementing manners.

In this embodiment, the first information is obtained by certain processing on the third information.

It should be noted that the step of obtaining the first information can be executed by the display device or another device besides the display device. If the step of obtaining the first information is executed by the another device besides the display device, the display device is usually informed of the first information and the second information by the another device, and the display device possibly does not know the third information.

In one optional implementing manner, the first information is obtained by transforming all or part of the third information according to a first transformation rule.

The first transformation rule can be a transformation rule in any type, comprising but not limited to: out-of-order transformation, operation transformation, mapping transformation and shielding transformation. The out-of-order transformation means change of a sequence of all or part of characters. For example, the first transformation rule is to reverse the sequence of all characters; and correspondingly, if the third information is 1A2B3C, the first information is C3B2A1. For another example, the first transformation rule is to circularly move the last three characters rightwards by 1 bit; correspondingly, if the third information is 1A2B3C, the first information is 1A2CB3. The operation transformation means certain operation on all or part of characters. For example, the first transformation rule is to add 2 to each number; correspondingly, if the third information is 1A2B3C, the first information is 3A4B5C. The mapping transformation means that all or part of characters are mapped to be characters in another system different from the system of the corresponding characters. For example, the first transformation rule is to map each number to be an English letter of a serial number corresponding to the number; and if the third information is 123456, the first information is ABCDEF. The shielding transformation means replacement of all or part of characters with specific characters. For example, the first transformation rule is to replace the two middle characters with *; and if the third information is 123456, the first information is 12**56.

In this implementing manner, the transformation is executed by the display device, that is, before 110, this embodiment further comprises:

obtaining, by the display device, the first information by transforming all or part of the third information according to the first transformation rule.

In addition, the display device can further determine the second information according to the first transformation rule or according to the first transformation rule and the third information.

In the implementing manner, the second information is associated with the first transformation rule.

In one possible scenario, the second information is a second transformation rule and the second transformation rule is same or reversible with the first transformation rule.

In this scenario, transformation indicated by the first transformation rule is usually reversible, that is, the user can perform on the first information reverse transformation of the transformation indicated by the first transformation rule to obtain the third information.

Specifically, the transformation type of the first transformation rule is not shielding transformation, that is, the type of the first transformation rule is optionally out-of-order transformation, operation transformation or mapping transformation.

Specifically, when the second transformation rule and the first transformation rule are same, in 120, the user knows how to transform the third information to obtain the first information, and therefore, the user can reversely derive the third information according to the first information and the second transformation rule. For example, the reverse transformation of the transformation indicated by the second transformation rule is performed on the first information to obtain the third information.

Specifically, the second transformation rule is reversible with the first transformation rule means that the transformation indicated by the second transformation rule is reverse transformation indicated by the first transformation rule. When the second transformation rule and the first transformation rule are reversible, after 120, the user can perform on the first information the transformation indicated by the second transformation rule to obtain the third information. For example, if the first transformation rule is to add 2 to each number, the second transformation rule is to subtract 2 from each number; if the first transformation rule is to map each number to an English letter of a serial number corresponding to the number, the second transformation rule is to map each English letter to a number of a serial number corresponding to the English letter.

In this scenario, the first transformation rule can be one of at least one transformation rule predetermined together with the user. When multiple transformation rules are predetermined together with the user, the multiple transformation rules can be transformation rules in different or same type.

In another possible scenario, the second information comprises at least one transformation parameter of the first transformation rule.

In this scenario, the first transformation rule generally is determined by a transformation manner and the at least one transformation parameter, wherein the transformation manner can be optionally predetermined together with the user.

For example, when the transformation manner is to add a natural number to each number and the at least transformation parameter is 2, the first transformation rule is to 2 to each number; and when the transformation manner is to circularly move all characters rightwards and the at least transformation parameter is 3, the first transformation rule is to circularly move all characters by 3 bits rightwards.

In this scenario, transformation indicated by the first transformation rule is usually reversible, that is, the user can perform on the first information reverse transformation of the transformation indicated by the first transformation rule to obtain the third information. Specifically, the type of the first transformation rule is not shielding transformation, that is, the type of the first transformation rule is optionally out-of-order transformation, operation transformation or mapping transformation.

In another possible scenario, the second information is the part of the third information.

In this scenario, the first information is obtained by transforming the part of the third information according to a first transformation rule. In addition, other parts besides the part in the third information are not transformed, that is, the first information comprises the other parts. Further, when the display device displays the first information, the other parts of the transformed part in the first information may be displayed in a highlighted manner to prompt the user.

For example, if the first transformation rule is to transform the last three characters into “*”, the second information is the last three characters of the third information. Correspondingly, if the third information is 123456, the first information is 123*** and the second information is 456.

In this embodiment, there is a plurality of implementing manners for 120.

In one possible implementing manner, the providing second information for a user in a touch manner comprises:

controlling at least one contact region that is on the display device and in contact with the user to generate deformation at least according to the second information.

That is, the display device transmits the second information to the user through deformation of the at least one contact region.

The at least one contact region is a deformable region, and can be optionally made of any flexible material.

The deformation of the at least one contact region identifies the second information.

In one possible scenario, the at least one contact region identifies the second information.

In this scenario, optionally, the controlling at least one contact region that is on the display device and in contact with the user to generate deformation at least according to the second information comprises:

determining at least one contact region that is on the display device and corresponding to the second information; and

controlling the at least one contact region to generate deformation.

The user optionally contacts one or more regions on the display device. For the purpose of expression, each region that is on the display device and in contact with the user is called as a contact region, that is, at least one contact region optionally exists on the display device, and the at least one contact region is optionally distributed at any position of the display device, for example, on a display screen, a rear cover or a frame. It should be noted that not all contact regions, among in the at least one contact region on the display device, correspond to the second information.

There is a plurality of implementing manners for determining at least one contact region that is on the display device and corresponding to the second information.

Optionally, the determining at least one contact region that is on the display device and corresponding to the second information comprises:

recognizing multiple part limbs that are of the user and in contact with the display device;

determining at least one part limb corresponding to the second information among the multiple part limbs; and

determining at least one contact region that is on the display device and in contact with the at least one part limb as at least one contact region corresponding to the second information.

A correspondence between the multiple part limbs of the user and the second information can be preset.

The multiple part limbs optionally comprise but not limited to: finger pulps of multiple fingers. Specifically, there may be a plurality of manners for the display device to recognize finger pulps of the respective fingers, such as fingerprints.

For example, the finger pulps of the thumb, index finger, middle finger, ring finger and pinkie of the right hand of the user correspond to 1, 2, 3, 4, and 5, respectively. The display device recognizes that the finger pulps of the five fingers of the right hand of the user all contact the display device. If the first transformation rule is to add 2 to each number and the second information is 2, the at least one contact region corresponding to the second information is determined as a first contact region in contact with the index finger of the right hand of the user on the display device; and correspondingly, the first contact region is controlled to generate deformation. If the first transformation rule is to add 4 to each number and the second information is 4, the at least one contact region corresponding to the second information is determined as a second contact region in contact with the ring finger of the right hand of the user on the display device; and correspondingly, the second contact region is controlled to generate deformation.

Optionally, the determining at least one contact region that is on the display device and corresponding to the second information comprises:

determining at least one contact region corresponding to the second information among the at least one contact region at least according to a position of the at least one contact region that is on the display device and in contact with the user.

There may be a plurality of manners for the display device to determine a position of the at least one contact region that is on the display device and in contact with the user, for example, a close monitoring or pressure sensing.

A correspondence between the position of the at least one contact region and the second information can be preset. Specifically, the correspondence between possible contact region in different positions on the display device and different pieces of second information is preset.

For example, it is preset that a display screen, right frame, left frame, bottom frame and rear cover on the display device correspond to 1, 2, 3, 4 and 5, respectively. The display device determines that the three contact regions in contact with the user are positioned on the display screen, right frame and rear cover, respectively. If the first transformation rule is to move each character by 2 bits rightwards and the second information is 2, the at least one contact region corresponding to the second information is determined as a first contact region positioned in the right frame in the three contact regions; and correspondingly, the first contact region is controlled to generate deformation. If the first transformation rule is to move each character by 5 bits rightwards and the second information is 5, the at least one contact region corresponding to the second information is determined as a second contact region positioned in the rear cover; and correspondingly, the second contact region is controlled to generate deformation.

In another possible scenario, the deformation identifies the second information.

In this scenario, optionally, the controlling at least one contact region that is on the display device and in contact with the user to generate deformation at least according to the second information comprises:

determining at least one deformation parameter corresponding to the second information at least according to the second information; and

controlling at least one contact region that is on the display device and in contact with the user to generate deformation according to the at least one deformation parameter.

The at least one deformation parameter optionally comprises but not limited to at least one of the following: a deformation shape, a deformation degree, a deformation area, a deformation duration, the number of deformations and a deformation frequency.

Specifically, the deformation shape means the shape capable of perceived by the user after the at least one contact region generates the deformation, for example, the shape of a top end of the at least one deformation degree and deformation area raised region. The deformation shape comprises but not limited to a circle, a square and a triangle. The deformation degree means deformation change degree, and can be specifically identified by a height change before and after the deformation of the at least one contact region. The deformation area means the area of the region generating the deformation in the at least one contact region. The deformation duration means the duration that the at least one contact region keeps the deformation state. The number of deformations means the number of times that the at least one contact region generates deformation and specifically means the number of changes of the at least one contact region to a deformation state from a non-deformation state; and the deformation frequency is the number of deformations of the at least one contact region in certain time.

For example, it is preset that the circle, the square and the triangle correspond to 1, 2 and 3, respectively. If the first transformation rule is to circularly move each character by 2 bits rightwards and the second information is 3, the deformation shape corresponding to the second information is a triangle; and correspondingly, the at least one contact region is controlled to be deformed, and the deformed shape is triangle.

In another possible implementing manner, the providing second information for a user in a touch manner comprises:

controlling at least one contact region that is on the display device and in contact with the user to generate vibration at least according to the second information.

That is to say, the display device transmits the second information to the user through the vibration of the at least one contact region.

The display device can generate vibration in many manners, for example, by a build-in motor.

The vibration of the at least one contact region identifies the second information.

In one possible scenario, the at least one contact region identifies the second information.

In this scenario, optionally, the controlling at least one contact region that is on the display device and in contact with the user to generate vibration at least according to the second information comprises:

determining at least one contact region that is on the display device and corresponding to the second information; and

controlling the at least one contact region to generate vibration.

Specific implementing of this scenario can refer to the similar scenario in previous implementing manner.

In another possible scenario, the vibration identifies the second information.

In this scenario, optionally, the controlling at least one contact region that is on the display device and in contact with the user to generate vibration at least according to the second information comprises:

determining at least one vibration parameter corresponding to the second information at least according to the second information; and

controlling at least one contact region that is on the display device and in contact with the user to generate vibration at least according to the at least one vibration parameter.

The at least one vibration parameter optionally comprises but not limited to at least one of the following: a vibration amplitude, a vibration frequency and a vibration duration.

FIG. 2 is a schematic structural diagram of a first embodiment of a display device provided by the present invention. As shown in FIG. 2, a display device 200 comprises:

a display module 21, configured to display first information; and

a touch control module 22, configured to provide second information for a user in a touch manner, wherein the second information is used for combining with the first information to obtain third information.

In this embodiment, the display device 200 can be any device having a display function, comprising but not limited to: a cellphone, a tablet computer, a wearable device and a display.

In this embodiment, the display device 200 optionally comprises a display screen, displaying, by the display module 21, the first information specifically is displaying the first information on the display screen, and correspondingly, all users located within a view angle range of the display screen can see the first information.

In this embodiment, since only the two contact parties can perceive the information provided in the touch manner, that is, in the process that the touch control module 22 provides the second information for the user in the touch manner, the second information cannot be perceived by another user besides the user, that is, it is impossible for the another user to obtain the second information in the process that the touch control module 22 provides the second information for the user in the touch manner.

In this embodiment, the third information is different from the first information, wherein the third information is information that the display device 200 really wants to provide for the user and can be called as real information; the first information can be regarded as disguised third information, and can be called as disguise information correspondingly; and the second information can assist the user in restoring the disguise information to the real information and is called as assistant information correspondingly.

In this embodiment, the third information is optionally privacy information, comprising any one of the following: an account, a password and a command.

In this embodiment, the third information optionally consists of at least one character.

By the display device of this embodiment, first information is displayed by the display module, and second information is provided for a user by the touch control module in a touch manner and is used for combining with the first information to obtain third information, thereby providing an interaction solution. Specifically, disguise information of real information is displayed and assistant information capable of restoring the disguise information is provided for the user in a relatively secret touch manner, to cause the user to restore the disguise information to the real information, thereby improving security and privacy.

The display device 200 of this embodiment is further described in some optional implementing manners.

In this embodiment, the first information is obtained by certain processing on the third information.

It should be noted that the first information can be obtained by any module of the display device 200 or the display module 21 is informed of the first information after another device besides the display device obtains the first information.

In one optional implementing manner, the first information is obtained by transforming all or part of the third information according to a first transformation rule.

In this implementing manner, optionally, the transformation is executed by the display device, that is, as shown in FIG. 3, the display device further comprises:

a transformation module 23, configured to obtain the first information by transforming all or part of the third information according to the first transformation rule.

In addition, the transformation module 23 is optionally configured to determine the second information according to the first transformation rule or according to the first transformation rule and the third information.

In the implementing manner, the second information is associated with the first transformation rule.

In one possible scenario, the second information is a second transformation rule and the second transformation rule is same or reversible with the first transformation rule.

In another possible scenario, the second information comprises at least one transformation parameter of the first transformation rule.

In another possible scenario, the second information is the part of the third information.

This implementing manner and specific description of each scenario of this implementing manner can refer to corresponding description in the embodiment of the interaction method provided by the present invention.

In this embodiment, there is a plurality of implementing manners for the touch control module 22.

In one possible implementing manner, the touch control module 22 is specifically configured to:

control at least one contact region that is on the display device 200 and in contact with the user to generate deformation at least according to the second information.

In one possible scenario, the at least one contact region identifies the second information.

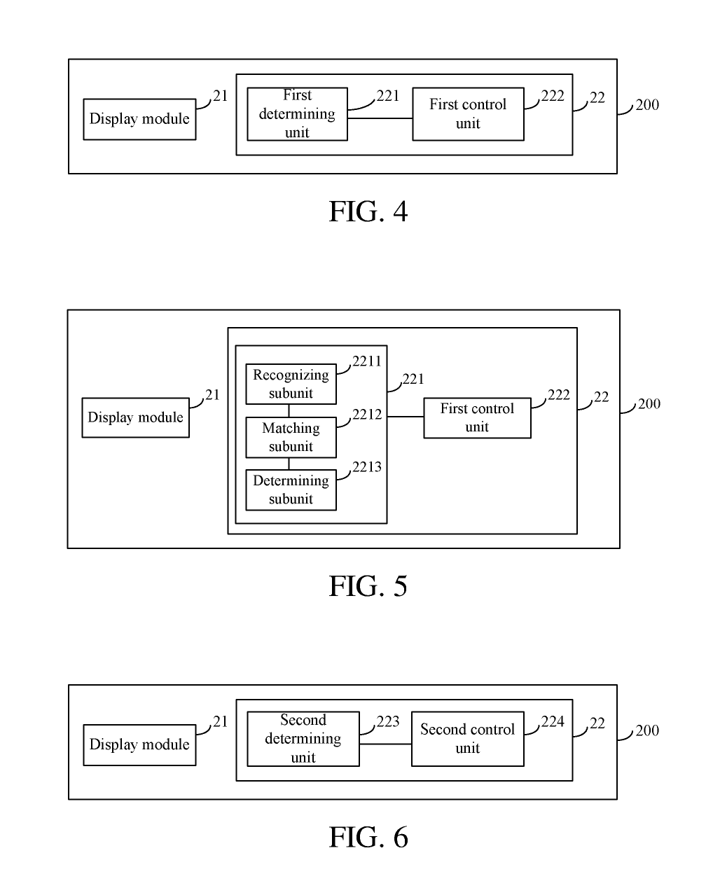

In this scenario, optionally, as shown in FIG. 4, the touch control module 22 comprises:

a first determining unit 221, configured to determine at least one contact region that is on the display device 200 and corresponding to the second information; and

a first control unit 222, configured to control the at least one contact region to generate deformation.

There is a plurality of implementing manners for the first determining unit 221.

Optionally, as shown in FIG. 5, the first determining unit 221 comprises:

a recognizing subunit 2211, configured to recognize multiple part limbs that are of the user and in contact with the display device 200;

a matching subunit 2212, configured to determine at least one part limb corresponding to the second information among the multiple part limbs; and

a determining subunit 2213, configured to determine at least one contact region that is on the display device 200 and in contact with the at least one part limb as at least one contact region corresponding to the second information.

The multiple part limbs optionally comprise but not limited to: finger pulps of multiple fingers.

In another possible scenario, optionally, as shown in FIG. 6, the touch control module 22 comprises:

a second determining unit 223, configured to determine at least one deformation parameter corresponding to the second information at least according to the second information; and

a second control unit 224, configured to control at least one contact region that is on the display device and in contact with the user to generate deformation according to the at least one deformation parameter.

The at least one deformation parameter optionally comprises but not limited to at least one of the following: a deformation shape, a deformation degree, a deformation area, a deformation duration, the number of deformations and a deformation frequency.

This implementing manner and specific description of each scenario of this implementing manner can refer to corresponding description in the embodiment of the interaction method provided by the present invention.

In another possible implementing manner, the touch control module 22 is specifically configured to:

control at least one contact region that is on the display device 200 and in contact with the user to generate vibration at least according to the second information.

In one possible scenario, the at least one contact region identifies the second information.

In this scenario, optionally, the touch control module 22 comprises:

a third determining unit, configured to determine at least one contact region that is on the display device and corresponding to the second information; and

a third control unit, configured to control the at least one contact region to generate vibration.

In another possible scenario, the vibration identifies the second information.

In this scenario, optionally, the touch control module 22 comprises:

a fourth determining unit, configured to determine at least one vibration parameter corresponding to the second information at least according to the second information; and a fourth control unit, configured to control at least one contact region that is on the display device and in contact with the user to generate vibration at least according to the at least one vibration parameter.

This implementing manner and specific description of each scenario of this implementing manner can refer to corresponding description in the embodiment of the interaction method provided by the present invention.

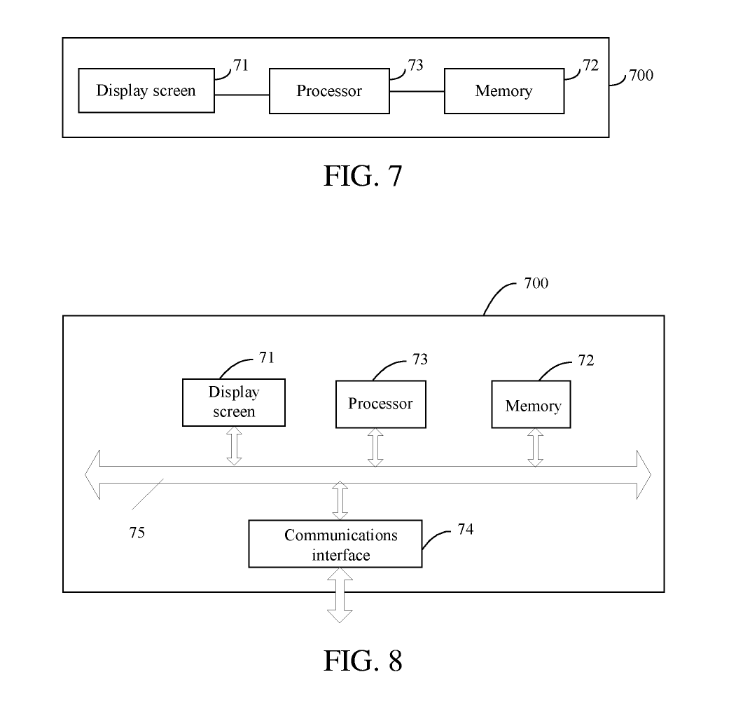

FIG. 7 is a schematic structural diagram of a second embodiment of a display device provided by the present invention. As shown in FIG. 7, the display device 700 comprises:

at least one display screen 71, configured to display;

a memory 72, configured to store an instruction;

a processor 73, configured to execute the instruction stored by the memory 72, wherein the instruction enables the processor 73 to execute the following operations:

controlling the at least one display screen 71 to display first information; and

providing second information for a user in a touch manner, wherein the second information is used for combining with the first information to obtain third information.

In this embodiment, the display device 700 can be any device having a display function, comprising but not limited to: a cellphone, a tablet computer, a wearable device and a display.

In this embodiment, the at least one display screen 71 is one or more display screens 71, and FIG. 7 shows one display screen 71 and is not intended to limit the number of display screens 71 in the display device 700.

In this embodiment, the memory 72 optionally may comprise a high speed RAM (Random-Access Memory), and optionally may further comprise a non-volatile memory, for example, at least one disk memory.

In this embodiment, the processor 73 can be a central processing unit (CPU), or an application specific integrated circuit (ASIC), or configured as one or more integrated circuits that implement the above operations. The instruction enabling the processor 73 to execute the operations can refer to corresponding description in the embodiment of the interaction method, which is not described again herein.

In this embodiment, the display device 700 optionally may further comprise at least one deformable region, located in any position capable of contacting the user on the display device 700. The at least one deformable region is made of any flexible material. For example, the at least one display screen 700 is made of a flexible material, and/or a frame of the display device 700 is made of the flexible material, and/or a rear cover of the display device 700 is made of the flexible material.

In one optional implementing manner, as shown in FIG. 8, the display device 700 further comprises a communications interface 74 and a communications bus 77, wherein the communications interface 74 is configured to communicate between the display device 700 and other devices. The at least one display screen 71, the memory 72, the processor 73, and the communications interface 74 communicate with each other by the communications bus 77.

Beneficial effects of this embodiment refer to corresponding description in the interaction method embodiment provided according to the present invention.

It can be appreciated by a person of ordinary skill in the art that, exemplary units and method steps described with reference to the embodiments disclosed in this specification can be implemented by electronic hardware or a combination of computer software and electronic hardware. Whether these functions are executed by hardware or software depends on specific applications and design constraints of the technical solution. A person skilled in the art may use different methods to implement the described functions for each specific application, but such implementation should not be construed as a departure from the scope of the present invention.

If the function is implemented in the form of a software functional unit and is sold or used as an independent product, the product can be stored in a computer-readable storage medium. Based on this understanding, the technical solution of the present invention essentially, or the part that contributes to the prior art, or a part of the technical solution may be embodied in the form of a software product; the computer software product is stored in a storage medium and comprises several instructions for enabling a computer device (which can be a personal computer, a server, a network device, or the like) to execute all or some of the steps of the method in the embodiments of the present invention. The foregoing storage medium comprises, but not limited to, a USB flash drive, a removable hard disk, a read-only memory (ROM), a random access memory (RAM), a magnetic disk or light disk and other mediums that can be used for storing a program code.

The foregoing implementations are only used to describe the present invention, but not to limit the present invention. A person of ordinary skill in the art can still make various alterations and modifications without departing from the spirit and scope of the present invention; therefore, all equivalent technical solutions also fall within the scope of the present invention and the patent protection scope of the present invention should be subject to the claims.

What is claimed is:

1. An interaction method, comprising:
displaying, by a display device, first information; and
providing second information for a user in a touch manner, wherein the second information is used for combining with the first information to obtain third information.

2. The method of claim 1, wherein the first information is obtained by transforming all or part of the third information according to a first transformation rule.

3. The method of claim 2, wherein, before the displaying, by a display device, first information, the method further comprises:
obtaining, by the display device, the first information by transforming all or part of the third information according to the first transformation rule.

4. The method of claim 2, wherein the second information is associated with the first transformation rule.

5. The method of claim 4, wherein the second information is a second transformation rule and the second transformation rule is same or reversible with the first transformation rule.

6. The method of claim 4, wherein the second information comprises at least one transformation parameter of the first transformation rule.

7. The method of claim 2, wherein the second information is the part of the third information.

8. The method according to claim 1, wherein the providing second information for a user in a touch manner comprises:
controlling at least one contact region that is on the display device and in contact with the user to generate deformation at least according to the second information.

9. The method of claim 8, wherein the controlling at least one contact region that is on the display device and in contact with the user to generate deformation at least according to the second information comprises:
determining at least one contact region that is on the display device and corresponding to the second information; and
controlling the at least one contact region to generate deformation.

10. The method of claim 9, wherein the determining at least one contact region that is on the display device and corresponding to the second information comprises:
recognizing multiple part limbs that are of the user and in contact with the display device;
determining at least one part limb corresponding to the second information among the multiple part limbs; and
determining at least one contact region that is on the display device and in contact with the at least one part limb as at least one contact region corresponding to the second information.

11. The method of claim 10, wherein the multiple part limbs comprise: finger pulps of multiple fingers.

12. The method of claim 8, wherein the controlling at least one contact region that is on the display device and in contact with the user to generate deformation at least according to the second information comprises:
determining at least one deformation parameter corresponding to the second information at least according to the second information; and
controlling at least one contact region that is on the display device and in contact with the user to generate deformation according to the at least one deformation parameter.

13. The method of claim 8, wherein the at least one deformation parameter comprises at least one of the following: a deformation shape, a deformation degree, a deformation area, a deformation duration, the number of deformations and a deformation frequency.

14. The method of claim 1, wherein the third information comprises any one of the following: an account, a password and a command.

15. A display device, characterized by comprising:
a display module, configured to display first information; and
a touch control module, configured to provide second information for a user in a touch manner, wherein the second information is used for combining with the first information to obtain third information.

16. The display device of claim 15, wherein the first information is obtained by transforming all or part of the third information according to a first transformation rule.

17. The display device of claim 16, wherein the display device further comprises: a transformation module, configured to obtain the first information by transforming all or part of the third information according to the first transformation rule.

18. The display device of claim 16, wherein the second information is associated with the first transformation rule.

19. The display device of claim 18, wherein the second information is a second transformation rule and the second transformation rule is same or reversible with the first transformation rule.

20. The display device of claim 18, wherein the second information comprises at least one transformation parameter of the first transformation rule.

21. The display device of claim 16, wherein the second information is the part of the third information.

22. The display device of claim 15, wherein the touch control module is specifically configured to control at least one contact region that is on the display device and in contact with the user to generate deformation at least according to the second information.

23. The display device of claim 22, wherein the touch control module comprises:
a first determining unit, configured to determine at least one contact region that is on the display device and corresponding to the second information; and
a first control unit, configured to control the at least one contact region to generate deformation.

24. The display device of claim 23, wherein the first determining unit comprises:
a recognizing subunit, configured to recognize multiple part limbs that are of the user and in contact with the display device;
a matching subunit, configured to determine at least one part limb corresponding to the second information among the multiple part limbs; and
a determining subunit, configured to determine at least one contact region that is on the display device and in contact with the at least one part limb as at least one contact region corresponding to the second information.

25. The display device of claim 24, wherein the multiple part limbs comprise: finger pulps of multiple fingers.

26. The display device of claim 22, wherein the touch control module comprises:
a second determining unit, configured to determine at least one deformation parameter corresponding to the second information at least according to the second information; and
a second control unit, configured to control at least one contact region that is on the display device and in contact with the user to generate deformation according to the at least one deformation parameter.

27. The display device of claim 26, wherein the at least one deformation parameter comprises at least one of the following: a deformation shape, a deformation degree, a deformation area, a deformation duration, the number of deformations and a deformation frequency.

28. The display device of claim 15, wherein the third information comprises any one of the following: an account, a password and a command.

29. A display device, characterized by comprising:
at least one display screen, configured to display;
a memory, configured to store an instruction;
a processor, configured to execute the instruction stored by the memory, wherein the instruction enables the processor to execute the following operations:
controlling the at least one display screen to display first information; and
providing second information for a user in a touch manner, wherein the second information is used for combining with the first information to obtain third information.
